(19) United States
(12) Patent Application Publication
(10) Pub. No.: US 2025/0381739 A1
(43) Pub. Date: Dec. 18, 2025

(54) METAL TO COMPOSITE JOINTS

(71) Applicant: The Boeing Company, Arlington, VA (US)

(72) Inventors: Michael Kenneth-Que Louie, Renton, WA (US); Scott Michael Spencer, Everett, WA (US); Marianne Elizabeth Wilkinson, Redmond, WA (US); Michael Alan Lee, Kent, WA (US)

(21) Appl. No.: 18/816,922

(22) Filed: Aug. 27, 2024

Related U.S. Application Data
(60) Provisional application No. 63/660,313, filed on Jun. 14, 2024.

(51) Int. Cl. B29C 65/00; B29L 31/30

(52) U.S. Cl. CPC B29C 66/342; B29C 66/12822; B29C 66/12842; B29C 66/721; B29C 66/7428; B29L 2031/3085

(57) ABSTRACT

Metal to composite joints and methods of forming are presented. A metal to composite joint for a platform comprises two metal structural components forming a portion of a first surface and a portion of a second surface of the metal to composite joint; and a dividing set of composite plies between the two metal structural components providing an escape path for volatiles between the two metal structural components.

### CROSS-REFERENCE TO RELATED APPLICATION

This application claims the benefit of Provisional U.S. Patent Application No. 63/660,313 filed Jun. 14, 2024, which is incorporated by reference herein in its entirety. This application is related to the following U.S. patent application entitled “Composite Panels with Titanium Ends,” Ser. No. ______, attorney docket no. 24-0409-US-NP, filed even date hereof, and assigned to the same assignee.

### BACKGROUND INFORMATION

### 1. Field

The present disclosure relates generally to forming composite joints and more specifically to forming metal to composite joints.

### 2. Background

In an aircraft, a metal to composite joint can be used to join wings to the body of the aircraft. The metal to composite joint can be a step lap joint between the composite plies and the metal component. In large structures, metal to composite joints present manufacturing challenges.

Gaps may be created at each step of a step lap metal to composite joint, introducing air into the laminate. On a thick large part, air and volatiles inside the laminate at the steps is undesirably difficult to evacuate during fabrication and autoclave cure. Remaining air and volatiles can lead to undesirable conditions such as porosity. To reduce inconsistencies, multiple cure cycles may be used, increasing cycle time and utilizing more resources.

Therefore, it would be desirable to have a method and apparatus that takes into account at least some of the issues discussed above, as well as other possible issues. It would be desirable to have a method and apparatus to reduce porosity within structures with metal to composite joints.

### SUMMARY

An embodiment of the present disclosure provides a metal to composite joint for a platform. The metal to composite joint comprises two metal structural components forming a portion of a first surface and a portion of a second surface of the metal to composite joint, and a dividing set of composite plies between the two metal structural components providing an escape path for volatiles between the two metal structural components.

Another embodiment of the present disclosure provides a metal to composite joint for a platform. The metal to composite joint comprises a first metal structural component comprising a stepped face and a planar face, a first set of composite plies comprising faying surfaces complementary to the stepped face of the first metal structural component, a second metal structural component comprising a stepped face and a planar face, a second set of composite plies comprising faying surfaces complementary to the stepped face of the second metal structural component, and a dividing set of composite plies between the two metal structural components providing an escape path for volatiles between the two metal structural components.

Yet another embodiment of the present disclosure provides a method of forming a metal to composite joint of a structure. A dividing set of composite plies is placed atop a first metal structural component. A second metal structural component is placed onto the dividing set of composite plies. The first metal structural component and the second metal structural component are bonded to the dividing set of composite plies.

A yet further embodiment of the present disclosure provides a method of removing volatiles from a metal to composite joint of a structure. The metal to composite joint is laid up with a dividing set of composite plies between a first metal structural component and a second metal structural component. The first metal structural component and the second metal structural component are bonded to the dividing set of composite plies. Volatiles are evacuated along the dividing set of composite plies and between the first metal structural component and the second metal structural component during bonding.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a metal to composite joint in accordance with an illustrative embodiment;

FIG. 4 is an illustration of a cross-sectional view of a metal to composite joint in accordance with an illustrative embodiment;

FIG. 5 is an illustration of a cross-sectional view of a metal to composite joint in accordance with an illustrative embodiment;

FIG. 6 is a flowchart of a method of forming a metal to composite joint of a structure in accordance with an illustrative embodiment;

FIG. 7 is a flowchart of a method of releasing volatiles from a metal to composite joint of a structure in accordance with an illustrative embodiment;

FIG. 8 is an illustration of an aircraft manufacturing and service method in a form of a block diagram in accordance with an illustrative embodiment; and

FIG. 9 is an illustration of an aircraft in a form of a block diagram in which an illustrative embodiment may be implemented.

### DETAILED DESCRIPTION

The illustrative examples recognize and take into account one or more considerations. The illustrative examples recognize and take into account that smaller composite parts have less issues with evacuating volatiles. The illustrative examples recognize and take into account that smaller composite parts have fewer volatiles as volatiles travel interlaminarly as opposed to through thickness. The illustrative examples recognize and take into account that air/volatiles travel significantly better between plies than through thickness.

The illustrative examples recognize and take into account that volatiles cannot move through titanium. The illustrative examples recognize and take into account that a hybrid titanium composite part will help reduce weight when compared to a titanium part.

The illustrative examples provide a new design that comprises titanium and carbon fiber composite. The titanium and carbon fiber composite can be used in airplane wing skins. In these illustrative examples, titanium is spliced to at least one end of a large composite structure.

The illustrative examples present metal to composite joints with more than one titanium component through the thickness. The illustrative examples “split” large titanium parts into two portions to allow for composite in between. The illustrative examples provide escape paths for air and volatiles through the composite layers between the titanium parts.

The illustrative examples improve both manufacturability as well as damage tolerance for titanium and composite structures. Splitting the titanium and using composite layers in between the titanium components helps manage scale for a design with titanium on the inboard side of a large wing skin or other sizeable part. The illustrative examples could be used on the inboard and outboard ends of wing skins for weight reduction.

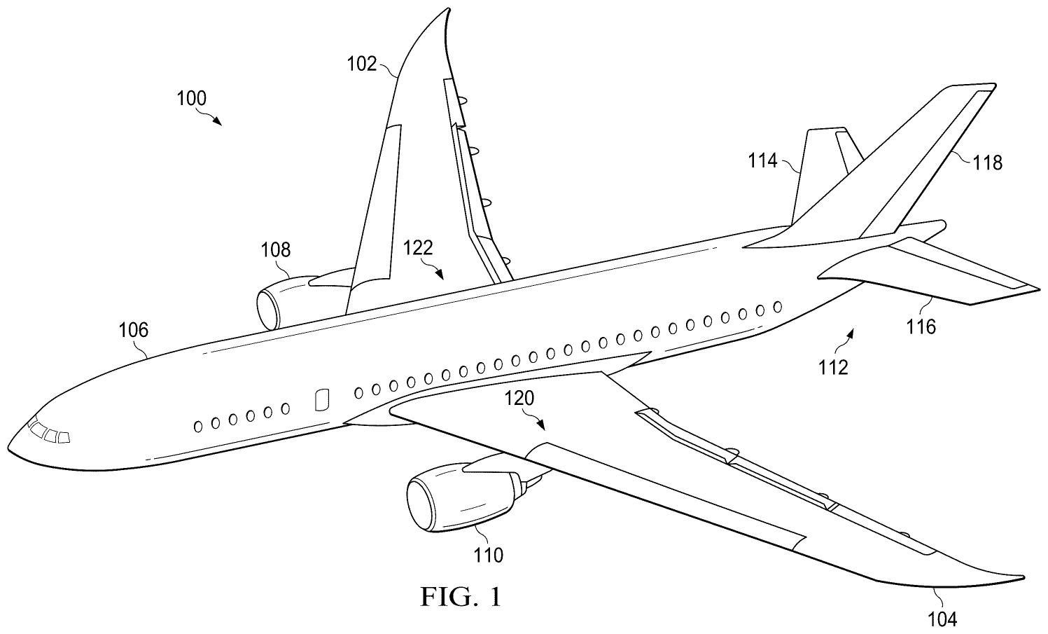

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have a metal to composite joint formed using the illustrative examples. The metal to composite joints of the illustrative examples can be used to connect at least one of wing 102 or wing 104 to body 106.

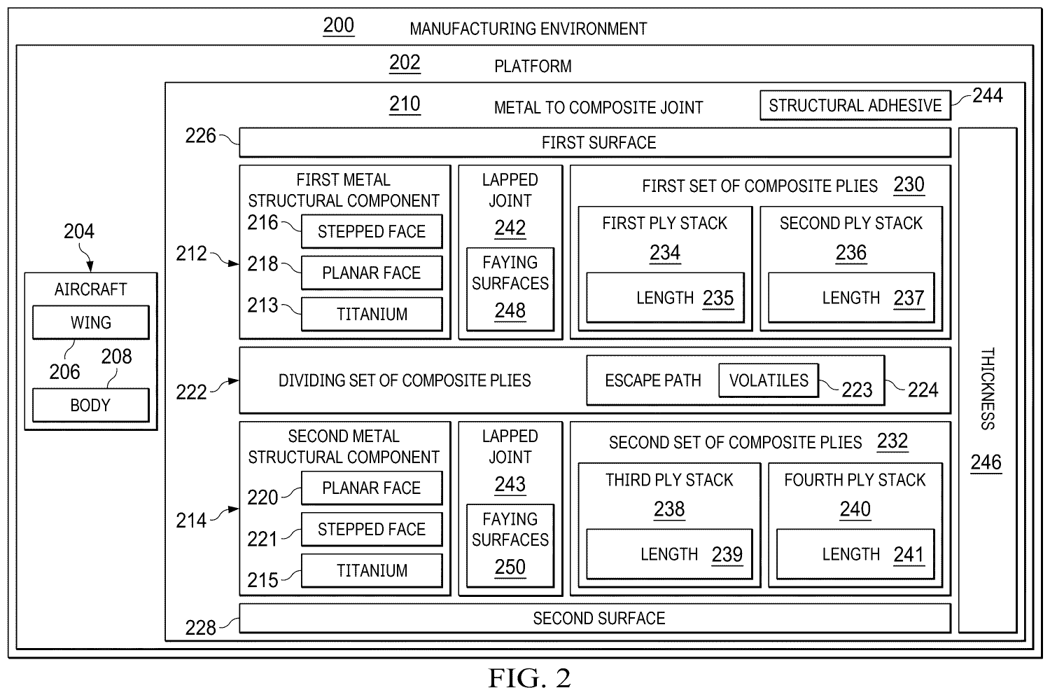

Turning now to FIG. 2, an illustration of a block diagram of a manufacturing environment is depicted in accordance with an illustrative embodiment. Metal to composite joint 210 of platform 202 can be formed in manufacturing environment 200.

Platform 202 can take a number of different forms. For example, platform 202 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a tanker aircraft, a surface ship, a tank, a personnel carrier, a train, a spacecraft, a space station, a satellite, a submarine, an automobile, a power plant, a bridge, a dam, a house, a manufacturing facility, a building, a robot, a robotic arm, a crane, and other suitable types of platforms.

In some illustrative examples, platform 202 can be aircraft 204. In some illustrative examples, platform 202 is wing 206 of aircraft 204.

In some illustrative examples, aircraft 100 of FIG. 1 can be a physical implementation of aircraft 204. In some illustrative examples, when metal to composite joint 210 is part of aircraft 204, metal to composite joint 210 can connect wing 206 to body 208 of aircraft 204.

Metal to composite joint 210 for platform 202 comprises first metal structural component 212 and second metal structural component 214 with dividing set of composite plies 222 between first metal structural component 212 and second metal structural component 214. As used herein, a “set” of items is one or more items. Dividing set of composite plies 222 comprises one or more composite plies. Dividing set of composite plies 222 provides escape path 224 for volatiles 223 in metal to composite joint 210. Escape path 224 extends interlaminarly within metal to composite joint 210 for platform 202.

Metal to composite joint 210 for platform 202 comprises first metal structural component 212, first set of composite plies 230, second metal structural component 214, second set of composite plies 232, and dividing set of composite plies 222. First metal structural component 212 comprises stepped face 216 and planar face 218.

First set of composite plies 230 comprises faying surfaces complementary to stepped face 216 of the first metal structural component 212. Second metal structural component 214 comprises stepped face 221 and planar face 220. Second set of composite plies 232 comprises faying surfaces complementary to stepped face 221 of second metal structural component 214. Dividing set of composite plies 222 between the two metal structural components provides escape path 224 for volatiles 223 between the two metal structural components. In some illustrative examples, first set of composite plies 230 is described as abutting stepped face 216 of the first metal structural component 212. In some illustrative examples, second set of composite plies 232 is described as abutting stepped face 221 of second metal structural component 214.

In some illustrative examples, first set of composite plies 230 is complementary to first metal structural component 212 to form lapped joint 242. Lapped joint 242 comprises faying surfaces 248 of first metal structural component 212 and first set of composite plies 230. In some illustrative examples, second set of composite plies 232 is complementary to second metal structural component 214 to form lapped joint 243. Lapped joint 243 comprises faying surfaces 250 of second metal structural component 214 and second set of composite plies 232. Dividing set of composite plies 222 extends between first set of composite plies 230 and second set of composite plies 232.

In some illustrative examples, dividing set of composite plies 222 extends between and is adhered to the planar faces of the two metal structural components, planar face 218 of first metal structural component 212 and planar face 220 of second metal structural component 214. In some illustrative examples, dividing set of composite plies 222 extends between and is adhered to the stepped faces of the two metal structural components, stepped face 216 of first metal structural component 212 and stepped face 221 of second metal structural component 214.

In some illustrative examples, first metal structural component 212 and second metal structural component 214 comprise titanium. As depicted, first metal structural component 212 comprises titanium 213. As depicted, second metal structural component 214 comprises titanium 215.

Metal to composite joint 210 comprises any desirable quantity of metal structural components with dividing composite plies between the metal structural components. In some illustrative examples, metal to composite joint 210 for platform 202 comprises two metal structural components forming a portion of first surface 226 and a portion of second surface 228 of metal to composite joint 210, and dividing set of composite plies 222 between the two metal structural components providing escape path 224 for volatiles 223 between the two metal structural components.

In some illustrative examples, stepped face 216 of first metal structural component 212 forms a portion of first surface 226. In some illustrative examples, planar face 218 forms a portion of first surface 226. The remainder of first surface 226 is formed by first set of composite plies 230. In some illustrative examples, first ply stack 234 of first set of composite plies 230 forms a portion of first surface 226.

In some illustrative examples, stepped face 221 of second metal structural component 214 forms a portion of second surface 228. In some illustrative examples, planar face 220 forms a portion of second surface 228. The remainder of second surface 228 is formed by second set of composite plies 232. In some illustrative examples, first ply stack 234 of first set of composite plies 230 forms a portion of first surface 226.

First set of composite plies 230 comprises faying surfaces 248 with first metal structural component 212 of the two metal structural components and second set of composite plies 232 comprises faying surfaces 250 with second metal structural component 214 of the two metal structural components to form lapped joint 242 and lapped joint 243. In some illustrative examples, first set of composite plies 230 can be described as abutting first metal structural component 212 of the two metal structural components and second set of composite plies 232 can be described as abutting second metal structural component 214 of the two metal structural components to form lapped joint 242 and lapped joint 243. First set of composite plies 230 forms lapped joint 242 with stepped face 216 of first metal structural component 212. In lapped joint 242, lengths of the ply stacks of first set of composite plies 230 vary to form a joint with stepped face 216 of first metal structural component 212. Second set of composite plies 232 forms lapped joint 243 with stepped face 221 of second metal structural component 214. In lapped joint 243, lengths of the ply stacks of second set of composite plies 232 vary to form a joint with stepped face 221 of second metal structural component 214.

When stepped face 216 forms a portion of first surface 226, first metal structural component 212 extends into first set of composite plies 230. When stepped face 216 forms a portion of first surface 226, longest plies of first set of composite plies 230 form a portion of first surface 226. In these illustrative examples, length 235 of first ply stack 234 forming a portion of first surface 226 is longer than length 237 of plies in second ply stack 236. Second ply stack 236 is farther into metal to composite joint 210 through thickness 246 moving from first surface 226 to second surface 228.

When stepped face 221 forms a portion of second surface 228, second metal structural component 214 extends into second set of composite plies 232. When stepped face 221 forms a portion of second surface 228, longest plies of second set of composite plies 232 form a portion of second surface 228. In these illustrative examples, length 241 of fourth ply stack 240 forming a portion of second surface 228 is longer than length 239 of plies in third ply stack 238. Third ply stack 238 is farther into metal to composite joint 210 through thickness 246 moving from second surface 228 to first surface 226.

In these illustrative examples, first metal structural component 212 and second metal structural component 214 appear to extend into the composite material of first set of composite plies 230 and second set of composite plies 232. In other illustrative examples, composite material of first set of composite plies 230 and second set of composite plies 232 appears to extend between first metal structural component 212 and second metal structural component 214.

When composite material of first set of composite plies 230 and second set of composite plies 232 appears to extend between first metal structural component 212 and second metal structural component 214, composite plies forming first surface 226 and second surface 228 have shortest lengths of first set of composite plies 230 and second set of composite plies 232.

In some illustrative examples, dividing set of composite plies 222 is adhered to the two metal structural components. In some illustrative examples, structural adhesive 244 is applied to at least one of dividing set of composite plies 222, first metal structural component 212 or second metal structural component 214.

Although not depicted in metal to composite joint 210, a third metal structural component can be present between the two metal structural components. In these illustrative examples, dividing set of composite plies 222 is adhered to one of the two metal structural components and the third metal structural component.

In some illustrative examples, the two metal structural components, first metal structural component 212 and second metal structural component 214, are symmetric about a center of metal to composite joint 210 through thickness 246. In other illustrative examples, the two metal structural components, first metal structural component 212 and second metal structural component 214, are asymmetric about a center of metal to composite joint 210 through thickness 246. In some illustrative examples, the two metal structural components, first metal structural component 212 and second metal structural component 214, have a same design. In other illustrative examples, the two metal structural components, first metal structural component 212 and second metal structural component 214, have different designs.

In some illustrative examples, structural adhesive 244 covers faying surfaces of the two metal structural components with first set of composite plies 230 and second set of composite plies 232. In some illustrative examples, structural adhesive 244 runs at least partially between first set of composite plies 230 and dividing set of composite plies 222. In some illustrative examples, structural adhesive 244 runs partially into first set of composite plies 230. In some illustrative examples, structural adhesive 244 runs at least partially between second set of composite plies 232 and dividing set of composite plies 222. In some illustrative examples, structural adhesive 244 runs partially into second set of composite plies 232.

In some illustrative examples, dividing set of composite plies 222 is bonded to the planar faces of the first metal structural component 212 and second metal structural component 214. In some illustrative examples, dividing set of composite plies 222 is bonded to the stepped faces of the first metal structural component 212 and second metal structural component 214.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, more than two metal structural components can be present. As another example, when more than two metal structural components are present, more than one set of dividing composite plies can be present.

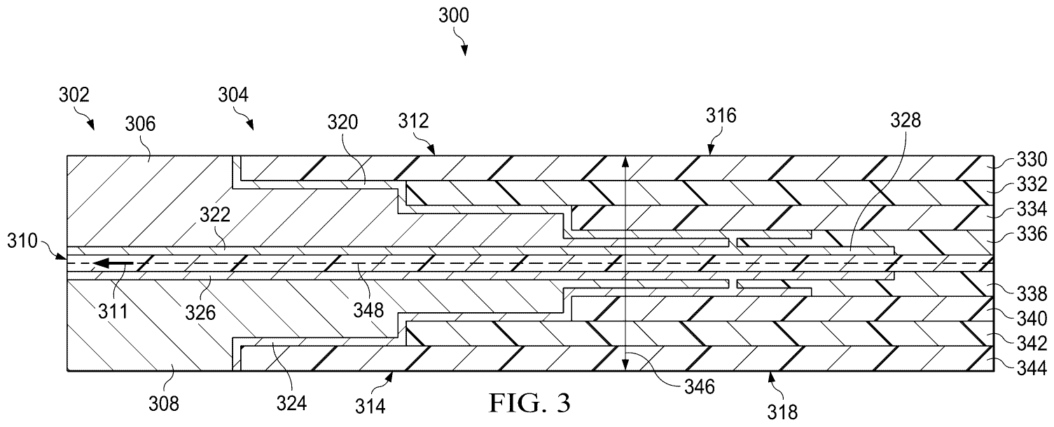

Turning now to FIG. 3, an illustration of a cross-sectional view of a metal to composite joint is depicted in accordance with an illustrative embodiment. Metal to composite joint 300 is a physical implementation of metal to composite joint 210 of FIG. 2. Metal to composite joint 300 comprises metal structural components 302 and composite material 304. Metal structural components 302 comprise first metal structural component 306 and second metal structural component 308.

The two metal structural components, first metal structural component 306 and second metal structural component 308, form a portion of first surface 316 and a portion of second surface 318 of the metal to composite joint 300. Dividing set of composite plies 310 is between the two metal structural components providing escape path 311 for volatiles between the two metal structural components. In this illustrative example, volatiles can escape from metal to composite joint 300 by traveling interlaminarly along dividing set of composite plies 310.

In this illustrative example, dividing set of composite plies 310 is adhered to the two metal structural components, first metal structural component 306 and second metal structural component 308. In this illustrative example, dividing set of composite plies 310 is bonded to planar face 322 of first metal structural component 306 and planar face 326 of second metal structural component 308. In this illustrative example, structural adhesive 328 adheres dividing set of composite plies 310 to each of planar face 322 and planar face 326.

Dividing set of composite plies 310 comprises any desirable quantity of composite plies. In some illustrative examples, dividing set of composite plies 310 comprises a stack-up of six composite plies.

First metal structural component 306 comprises stepped face 320 and planar face 322. Second metal structural component 308 comprises stepped face 324 and planar face 326. First set of composite plies 312 comprises faying surfaces complementary to first metal structural component 306 of the two metal structural components. Second set of composite plies 314 comprises faying surfaces complementary to second metal structural component 308 of the two metal structural components. First set of composite plies 312 is complementary to first metal structural component 306. Second set of composite plies 314 is complementary to second metal structural component 308.

First set of composite plies 312 comprises first ply stack 330, second ply stack 332, third ply stack 334, and fourth ply stack 336. Second set of composite plies 314 comprises fifth ply stack 338, sixth ply stack 340, seventh ply stack 342, and eighth ply stack 344.

In some illustrative examples, manufacturing acceptable gaps can be present between first sets of composite plies 312 and stepped face 320 of first metal structural component 306. In some illustrative examples, manufacturing acceptable gaps can be present between second sets of composite plies 314 and stepped face 324 of second metal structural component 308. The volatiles from the gaps can be evacuated through escape path 311 during processing of metal to composite joint 300.

In this illustrative example, the two metal structural components, first metal structural component 306 and second metal structural component 308, are symmetric about center 348 of metal to composite joint 300 through thickness 346. In this illustrative example, planar face 322 faces planar face 326 about center 348 of metal to composite joint 300 through thickness 346. In this illustrative example, the longest composite plies of first set of composite plies 312 form a portion of first surface 316. In this illustrative example, the longest composite plies of second set of composite plies 314 form a portion of second surface 318. In this illustrative example, the two metal structural components appear to “extend into” the composite material as the longest portions of stepped face 320 and stepped face 324 are near center 348.

Dividing set of composite plies 310 extends between first set of composite plies 312 and second set of composite plies 314. First set of composite plies 312 forms a lapped joint with stepped face 320 of first metal structural component 306. Second set of composite plies 314 forms a lapped joint with stepped face 324 of second metal structural component 308.

In this illustrative example, structural adhesive 328 covers faying surfaces of the two metal structural components, first metal structural component 306 and second metal structural component 308, with first set of composite plies 312 and second set of composite plies 314. In this illustrative example, structural adhesive 328 adheres first set of composite plies 312 to first metal structural component 306. In this illustrative examples, structural adhesive 328 adheres second set of composite plies 314 to second metal structural component 308. In this illustrative examples, structural adhesive 328 extends partially between some ply stacks of first set of composite plies 312. As depicted, structural adhesive 328 extends partially between third ply stack 334 and fourth ply stack 336. As depicted, structural adhesive 328 extends partially between fourth ply stack 336 and dividing set of composite plies 310. As depicted, structural adhesive 328 extends partially between dividing set of composite plies 310 and fifth ply stack 338. As depicted, structural adhesive 328 extends partially between fifth ply stack 338 and sixth ply stack 340.

In some illustrative examples, the two metal structural components, first metal structural component 306 and second metal structural component 308, comprise titanium. In some illustrative examples, titanium is used based on its compression strength.

In some illustrative examples, metal to composite joint 300 can be a component of a wing of an aircraft. In some illustrative examples, metal to composite joint 300 can connect a wing of an aircraft to the body of the aircraft.

As depicted, the two metal structural components comprise first metal structural component 306 comprising stepped face 320 and planar face 322, and second metal structural component 308 comprising stepped face 324 and planar face 326. In this illustrative example, the planar faces of first metal structural component 306 and second metal structural component 308 are internal to the platform. In this illustrative example, the stepped faces of first metal structural component 306 and second metal structural component 308 form part of surfaces of the platform.

Metal to composite joint 300 is a non-limiting example. In this illustrative example, metal to composite joint 300 is symmetric about center 348 through thickness 346. In other illustrative examples, metal to composite joint 300 can be asymmetric. Although four metal structural components are depicted, a metal to composite joint of the illustrative examples can have any desirable quantity of metal structural components. Additionally, although metal structural components 302 each extends towards the composite material an equal distance, in other illustrative examples at least one metal structural component can be a different size, different shape, or other different configuration.

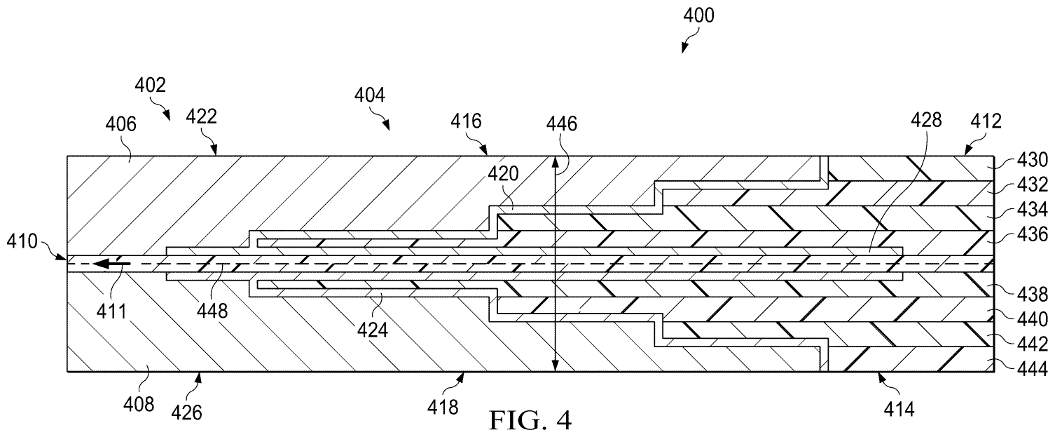

Turning now to FIG. 4, an illustration of a cross-sectional view of a metal to composite joint is depicted in accordance with an illustrative embodiment. Metal to composite joint 400 is a physical implementation of metal to composite joint 210 of FIG. 2. Metal to composite joint 400 comprises metal structural components 402 and composite material 404. Metal structural components 402 comprise first metal structural component 406 and second metal structural component 408.

The two metal structural components, first metal structural component 406 and second metal structural component 408, form a portion of first surface 416 and a portion of second surface 418 of the metal to composite joint 400. Dividing set of composite plies 410 is between the two metal structural components providing escape path 411 for volatiles between the two metal structural components. In this illustrative example, volatiles can escape from metal to composite joint 400 by traveling interlaminarly along dividing set of composite plies 410.

In this illustrative example, dividing set of composite plies 410 is adhered to the two metal structural components, first metal structural component 406 and second metal structural component 408. In this illustrative example, dividing set of composite plies 410 is bonded to stepped face 420 of first metal structural component 406 and stepped face 424 of second metal structural component 408. In this illustrative example, structural adhesive 428 adheres dividing set of composite plies 410 to each of stepped face 420 and stepped face 424.

Dividing set of composite plies 410 comprises any desirable quantity of composite plies. In some illustrative examples, dividing set of composite plies 410 comprises a stack-up of six composite plies.

First metal structural component 406 comprises stepped face 420 and planar face 422. Second metal structural component 408 comprises stepped face 424 and planar face 426. First set of composite plies 412 comprises faying surfaces complementary to first metal structural component 406 of the two metal structural components. Second set of composite plies 414 comprises faying surfaces complementary to second metal structural component 408 of the two metal structural components. First set of composite plies 412 is complementary to first metal structural component 406. Second set of composite plies 414 is complementary to second metal structural component 408.

First set of composite plies 412 comprises first ply stack 430, second ply stack 432, third ply stack 434, and fourth ply stack 436. Each stack of first set of composite plies comprises any desirable quantity of plies. In some illustrative examples, each stack of plies comprises six plies. Second set of composite plies 414 comprises fifth ply stack 438, sixth ply stack 440, seventh ply stack 442, and eighth ply stack 444.

In some illustrative examples, manufacturing acceptable gaps can be present between first sets of composite plies 412 and stepped face 420 of first metal structural component 406. In some illustrative examples, manufacturing acceptable gaps can be present between second sets of composite plies 414 and stepped face 424 of second metal structural component 408. The volatiles from the gaps can be evacuated through escape path 411 during processing of metal to composite joint 400.

In this illustrative example, the two metal structural components, first metal structural component 406 and second metal structural component 408, are symmetric about center 448 of metal to composite joint 400 through thickness 446. In this illustrative example, planar face 422 faces away from planar face 426 about center 448 of metal to composite joint 400 through thickness 446. In this illustrative example, stepped face 420 faces towards stepped face 424 about center 448 of metal to composite joint 400 through thickness 446. In this illustrative example, planar face 422 forms a portion of first surface 416. In this illustrative example, the shortest composite plies of first set of composite plies 412 form a portion of first surface 416. In this illustrative example, the shortest composite plies of second set of composite plies 414 form a portion of second surface 418. In this illustrative example, the two metal structural components appear to “extend into” the composite material as the longest portions of stepped face 420 and stepped face 424 are near center 448.

Dividing set of composite plies 410 extends between first set of composite plies 412 and second set of composite plies 414. First set of composite plies 412 forms a lapped joint with stepped face 420 of first metal structural component 406. Second set of composite plies 414 forms a lapped joint with stepped face 424 of second metal structural component 408.

In this illustrative example, structural adhesive 428 covers faying surfaces of the two metal structural components, first metal structural component 406 and second metal structural component 408, with first set of composite plies 412 and second set of composite plies 414. In this illustrative example, structural adhesive 428 adheres first set of composite plies 412 to first metal structural component 406. In this illustrative examples, structural adhesive 428 adheres second set of composite plies 414 to second metal structural component 408. As depicted, structural adhesive 428 extends partially between fourth ply stack 436 and dividing set of composite plies 410. As depicted, structural adhesive 428 extends partially between dividing set of composite plies 410 and fifth ply stack 438.

In some illustrative examples, the two metal structural components, first metal structural component 406 and second metal structural component 408, comprise titanium.

In some illustrative examples, metal to composite joint 400 can be a component of a wing of an aircraft. In some illustrative examples, metal to composite joint 400 can connect a wing of an aircraft to the body of the aircraft.

As depicted, the two metal structural components comprise first metal structural component 406 comprising stepped face 420 and planar face 422, and second metal structural component 408 comprising stepped face 424 and planar face 426. In this illustrative example, the planar faces of first metal structural component 406 and second metal structural component 408 are internal to the platform. In this illustrative example, the stepped faces of first metal structural component 406 and second metal structural component 408 form part of surfaces of the platform.

Metal to composite joint 400 is a non-limiting example. In this illustrative example, metal to composite joint 400 is symmetric about center 448 through thickness 446. In other illustrative examples, metal to composite joint 400 can be asymmetric. Although four metal structural components are depicted, a metal to composite joint of the illustrative examples can have any desirable quantity of metal structural components. Additionally, although metal structural components 402 each extends towards the composite material an equal distance, in other illustrative examples at least one metal structural component can be a different size, different shape, or other different configuration.

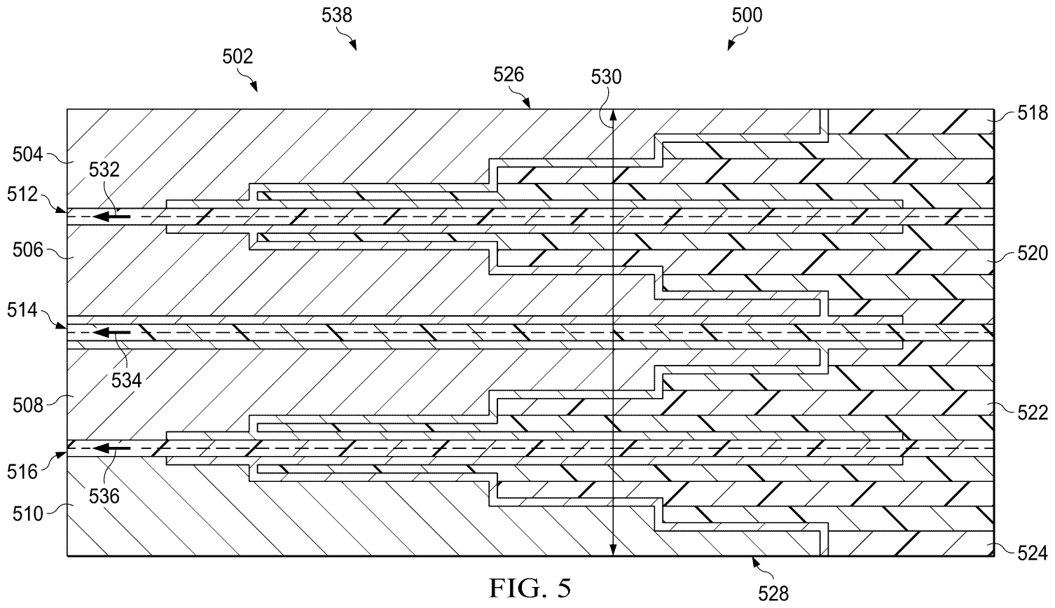

Turning now to FIG. 5, an illustration of a cross-sectional view of a metal to composite joint is depicted in accordance with an illustrative embodiment. Metal to composite joint 500 is a physical implementation of metal to composite joint 210. Metal to composite joint 500 comprises metal structural components 502 separated by sets of dividing composite plies. Metal structural components 502 comprises first metal structural component 504, second metal structural component 506, third metal structural component 508, and fourth metal structural component 510. In this illustrative example, the sets of dividing composite plies include dividing set of composite plies 512, dividing set of composite plies 514, and dividing set of composite plies 516.

In this illustrative example, metal to composite joint 500 further comprises first set of composite plies 518, second set of composite plies 520, third set of composite plies 522, and fourth set of composite plies 524. In this illustrative example, metal to composite joint 500 comprises first surface 526 and second surface 528. By moving through thickness 530 from first surface 526 to second surface 528 of metal to composite joint 500, each of metal structural components 502, first set of composite plies 518, dividing set of composite plies 512, second set of composite plies 520, dividing set of composite plies 514, third set of composite plies 522, dividing set of composite plies 516, and fourth set of composite plies 524.

In this illustrative example, each of the sets of dividing composite plies provides an escape path for volatiles from metal to composite joint 500. Dividing set of composite plies 512 provides escape path 532 for movement of volatiles. Dividing set of composite plies 514 provides escape path 534 for movement of volatiles. Dividing set of composite plies 516 provides escape path 536 for movement of volatiles.

By moving along escape path 532, escape path 534, or escape path 536, volatiles move interlaminarly through structure 538 having metal to composite joint 500. By providing dividing set of composite plies 512, dividing set of composite plies 514, and dividing set of composite plies 516, structure 538 has improved ability to be evacuated. Metal to composite joint 500 with dividing set of composite plies 512, dividing set of composite plies 514, and dividing set of composite plies 516 has a lower porosity than a structure with a single titanium component extending through thickness 530 without dividing composite plies. Metal to composite joint 500 with dividing set of composite plies 512, dividing set of composite plies 514, and dividing set of composite plies 516 can have a lower manufacturing time without repeated heating for evacuation. Metal to composite joint 500 with dividing set of composite plies 512, dividing set of composite plies 514, and dividing set of composite plies 516 can have improved quality due to the presence of the sets of dividing composite plies.

Metal to composite joint 500 is a non-limiting example. In this illustrative example, metal to composite joint 500 is symmetric about the center of metal to composite joint 500 through thickness 530. In other illustrative examples, metal to composite joint 500 can be asymmetric. Although four metal structural components are depicted, a metal to composite joint of the illustrative examples can have any desirable quantity of metal structural components. Additionally, although metal structural components 502 each extends towards the composite material an equal distance, in other illustrative examples at least one metal structural component can be a different size, different shape, or other different configuration.

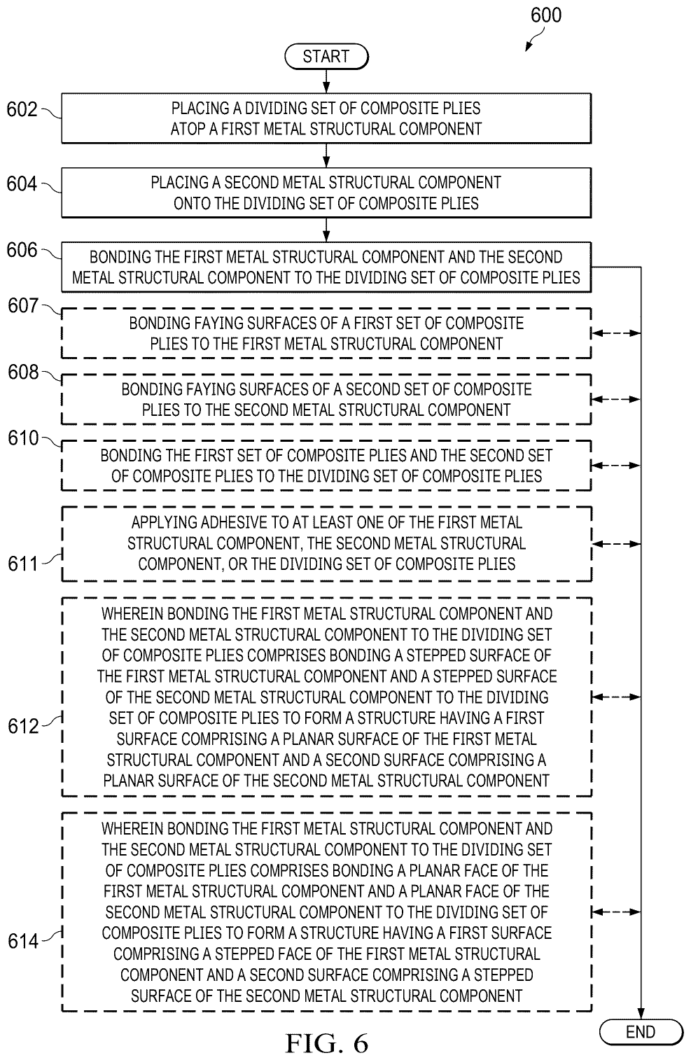

Turning now to FIG. 6, a flowchart of a method of forming a metal to composite joint of a structure is depicted in accordance with an illustrative embodiment. Method 600 can be used to form a metal to composite joint of aircraft 100 of FIG. 1. Method 600 can be used to form metal to composite joint 210 of FIG. 2. Method 600 can be used to form metal to composite joint 300 of FIG. 3. Method 600 can be used to form metal to composite joint 400 of FIG. 4. Method 600 can be used to form metal to composite joint 500 of FIG. 5.

Method 600 places a dividing set of composite plies atop a first metal structural component (operation 602). Method 600 places a second metal structural component onto the dividing set of composite plies (operation 604). Method 600 bonds the first metal structural component and the second metal structural component to the dividing set of composite plies (operation 606). Afterwards, method 600 terminates.

In some illustrative examples, method 600 bonds faying surfaces of a first set of composite plies to the first metal structural component (operation 607). In some illustrative examples, the first set of composite plies forms a stepped joint with first metal structural component. In some illustrative examples, the first set of composite plies form a portion of a surface of the metal to composite joint of the structure.

In some illustrative examples, method 600 bonds faying surfaces of a second set of composite plies to the second metal structural component (operation 608). In some illustrative examples, the second set of composite plies forms a stepped joint with the second metal structural component. In some illustrative examples, the second set of composite plies form a portion of a surface of the metal to composite joint of the structure.

In some illustrative examples, method 600 bonds the first set of composite plies and the second set of composite plies to the dividing set of composite plies (operation 610). In some illustrative examples, the first set of composite plies and the second set of composite plies are co-bonded to the dividing set of composite plies. In some illustrative examples, an adhesive extends partially between the first set of composite plies and the dividing set of composite plies. In some illustrative examples, an adhesive extends partially between the second set of composite plies and the dividing set of composite plies.

In some illustrative examples, method 600 applies adhesive to at least one of the first metal structural component, the second metal structural component, or the dividing set of composite plies (operation 611). In some illustrative examples, the adhesive is positioned between the first metal structural component and the dividing set of composite plies. In some illustrative examples, the adhesive is positioned between the second metal structural component and the dividing set of composite plies. In some illustrative examples, the adhesive is positioned between the first metal structural component and the first set of composite plies. In some illustrative examples, the adhesive is positioned between the second metal structural component and the second set of composite plies.

In some illustrative examples, bonding the first metal structural component and the second metal structural component to the dividing set of composite plies comprises bonding a stepped face of the first metal structural component and a stepped face of the second metal structural component to the dividing set of composite plies to form a structure having a first surface comprising a planar face of the first metal structural component and a second surface comprising a planar face of the second metal structural component (operation 612). In some illustrative examples, a longest surface of the first metal structural component in a length of the structure forms a portion of the first surface. In some illustrative examples, a longest surface of the second metal structural component in a length of the structure forms a portion of the second surface. In these illustrative examples, the composite material can appear to extend between the metal structural components.

In some illustrative examples, bonding the first metal structural component and the second metal structural component to the dividing set of composite plies comprises bonding a planar face of the first metal structural component and a planar face of the second metal structural component to the dividing set of composite plies to form a structure having a first surface comprising a stepped face of the first metal structural component and a second surface comprising a stepped face of the second metal structural component (operation 614). In some illustrative examples, a longest surface of the first metal structural component in a length of the structure is in a center of the metal to composite joint. In some illustrative examples, a longest surface of the second metal structural component in a length of the structure is in a center of the metal to composite joint. In these illustrative examples, the metal structural components can appear to extend into the composite material.

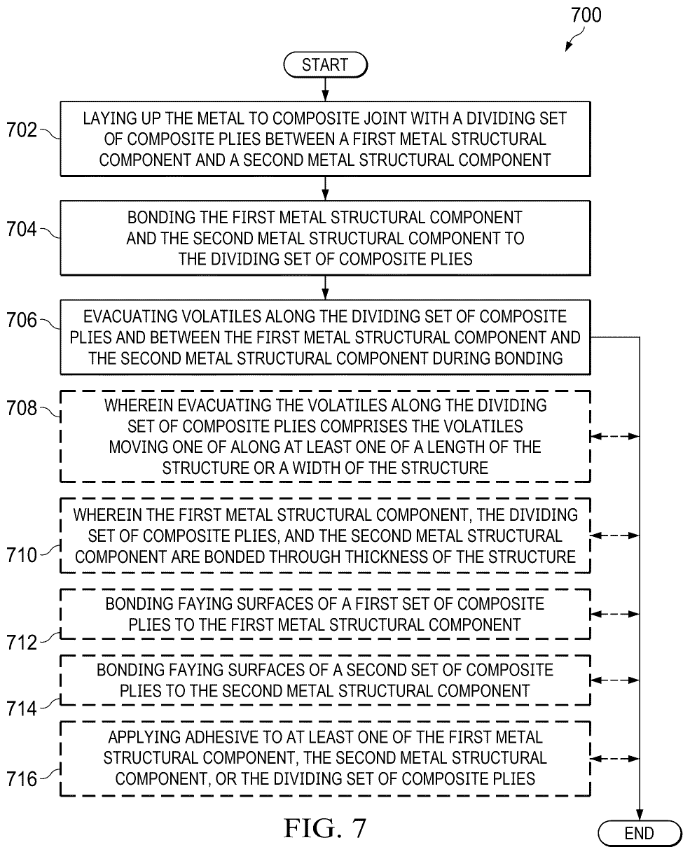

Turning now to FIG. 7, a flowchart of a method of releasing volatiles from a metal to composite joint of a structure is depicted in accordance with an illustrative embodiment. Method 700 can be used to release volatiles from a metal to composite joint of aircraft 100 of FIG. 1. Method 700 can be used to form metal to composite joint 210 of FIG. 2. Method 700 can be used to form metal to composite joint 300 of FIG. 3. Method 700 can be used to form metal to composite joint 400 of FIG. 4. Method 700 can be used to form metal to composite joint 500 of FIG. 5.

Method 700 lays up the metal to composite joint with a dividing set of composite plies between a first metal structural component and a second metal structural component (operation 702). Method 700 bonds the first metal structural component and the second metal structural component to the dividing set of composite plies (operation 704). Method 700 evacuates volatiles along the dividing set of composite plies and between the first metal structural component and the second metal structural component during bonding (operation 706). Afterwards, method 700 terminates.

In some illustrative examples, evacuating the volatiles along the dividing set of composite plies comprises the volatiles moving one of along at least one of a length of the structure or a width of the structure (operation 708). By moving along the length or the width of the structure, the volatiles move interlaminarly in the structure. By moving along the length or the width of the structure, the volatiles do not move through the thickness in the structure.

In some illustrative examples, the first metal structural component, the dividing set of composite plies, and the second metal structural component are bonded through thickness of the structure (operation 710). In these illustrative examples, when moving through the metal to composite joint through the thickness, each of the first metal structural component, the dividing set of composite plies, and the second metal structural component are encountered.

In some illustrative examples, method 700 bonds faying surfaces of a first set of composite plies to the first metal structural component (operation 712). In some illustrative examples, the first set of composite plies forms a stepped joint with first metal structural component. In some illustrative examples, the first set of composite plies form a portion of a surface of the metal to composite joint of the structure.

In some illustrative examples, method 700 bonds faying surfaces of a second set of composite plies to the second metal structural component (operation 714). In some illustrative examples, the second set of composite plies forms a stepped joint with the second metal structural component. In some illustrative examples, the second set of composite plies form a portion of a surface of the metal to composite joint of the structure.

In some illustrative examples, method 700 applies adhesive to at least one of the first metal structural component, the second metal structural component, or the dividing set of composite plies (operation 716). In some illustrative examples, the adhesive is positioned between the first metal structural component and the dividing set of composite plies. In some illustrative examples, the adhesive is positioned between the second metal structural component and the dividing set of composite plies. In some illustrative examples, the adhesive is positioned between the first metal structural component and the first set of composite plies. In some illustrative examples, the adhesive is positioned between the second metal structural component and the second set of composite plies.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 607 through operation 614 may be optional. As another example, operation 708 through operation 716 may be optional.

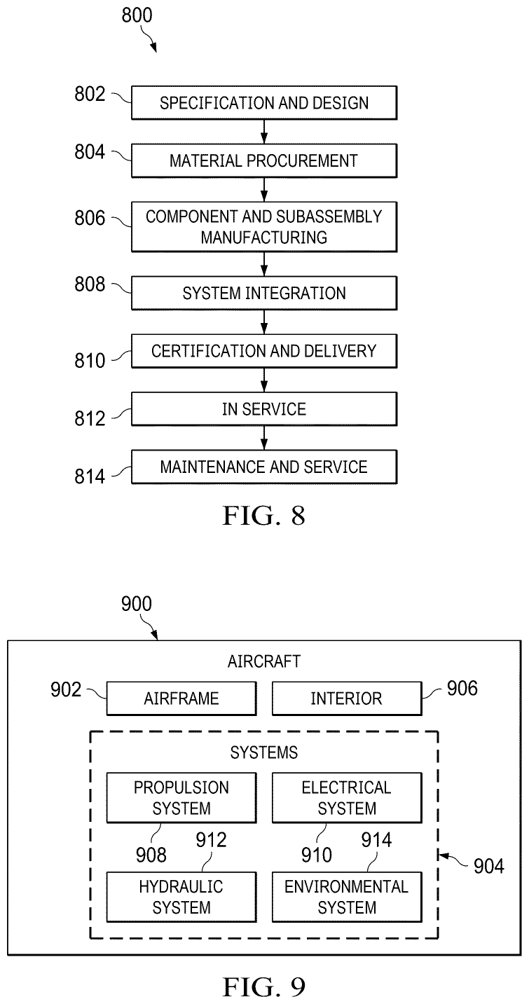

Illustrative embodiments of the present disclosure may be described in the context of aircraft manufacturing and service method 800 as shown in FIG. 8 and aircraft 900 as shown in FIG. 9. Turning first to FIG. 8, an illustration of an aircraft manufacturing and service method in a form of a block diagram is depicted in accordance with an illustrative embodiment. During pre-production, aircraft manufacturing and service method 800 may include specification and design 802 of aircraft 900 in FIG. 8 and material procurement 804.

During production, component and subassembly manufacturing 806 and system integration 808 of aircraft 900 takes place. Thereafter, aircraft 900 may go through certification and delivery 810 in order to be placed in service 812. While in service 812 by a customer, aircraft 900 is scheduled for routine maintenance and service 814, which may include modification, reconfiguration, refurbishment, or other maintenance and service.

Each of the processes of aircraft manufacturing and service method 800 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in a form of a block diagram is depicted in which an illustrative embodiment may be implemented. In this example, aircraft 900 is produced by aircraft manufacturing and service method 800 of FIG. 8 and may include airframe 902 with plurality of systems 904 and interior 906. Examples of systems 904 include one or more of propulsion system 908, electrical system 910, hydraulic system 912, and environmental system 914. Any number of other systems may be included.

Apparatuses and methods embodied herein may be employed during at least one of the stages of aircraft manufacturing and service method 800. One or more illustrative embodiments may be manufactured or used during at least one of component and subassembly manufacturing 806, system integration 808, in service 812, or maintenance and service 814 of FIG. 8.

The illustrative examples present metal to composite joints with multiple metal structural components. Splitting the titanium into two or more components provides improved part quality and ease of manufacturability. Composite plies can be more easily positioned between two titanium components than inserted into a concavity of a single titanium component.

The illustrative examples enables a weight reduction for airplane wing designs. The illustrative examples provides benefits in quality and damage tolerance.

In the illustrative examples, volatiles and air travel along dividing pling between the Titanium components. The titanium is split through the thickness with additional layers of composite in between to aid in volatile removal during fabrication. The illustrative examples can provide damage tolerance improvements in service. The illustrative examples can improve prevention of crack propagation.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A metal to composite joint for a platform comprising:
two metal structural components forming a portion of a first surface and a portion of a second surface of the metal to composite joint; and
a dividing set of composite plies between the two metal structural components providing an escape path for volatiles between the two metal structural components.

2. The metal to composite joint of claim 1, wherein the dividing set of composite plies is adhered to the two metal structural components.

3. The metal to composite joint of claim 1 further comprising:
a third metal structural component between the two metal structural components, wherein the dividing set of composite plies is adhered to one of the two metal structural components and the third metal structural component.

4. The metal to composite joint of claim 1 further comprising:
a first set of composite plies comprising faying surfaces with a first metal structural component of the two metal structural components; and
a second set of composite plies comprising faying surfaces with a second metal structural component of the two metal structural components.

5. The metal to composite joint of claim 4, wherein the first set of composite plies is complementary to the first metal structural component, and wherein the second set of composite plies is complementary to the second metal structural component.

6. The metal to composite joint of claim 1, wherein the two metal structural components are symmetric about a center of the metal to composite joint through the thickness.

7. The metal to composite joint of claim 4, wherein the dividing set of composite plies extends between the first set of composite plies and the second set of composite plies.

8. The metal to composite joint of claim 4, wherein the first set of composite plies forms a lapped joint with a stepped face of the first metal structural component.

9. The metal to composite joint of claim 4, wherein the second set of composite plies forms a lapped joint with a stepped face of the second metal structural component.

10. The metal to composite joint of claim 4, a structural adhesive covering faying surfaces of the two metal structural components with the first set of composite plies and the second set of composite plies.

11. The metal to composite joint of claim 1, wherein the two metal structural components comprise titanium.

12. The metal to composite joint of claim 1, wherein the platform is a wing of an aircraft.

13. The metal to composite joint of claim 1, wherein the two metal structural components comprise:
a first metal structural component comprising a stepped face and a planar face; and
a second metal structural component comprising a stepped face and a planar face, wherein the planar faces of the first metal structural component and the second metal structural component form surfaces of the platform.

14. The metal to composite joint of claim 1, wherein the two metal structural components comprise:
a first metal structural component comprising a stepped face and a planar face; and
a second metal structural component comprising a stepped face and a planar face, wherein the dividing set of composite plies is bonded to the planar faces of the first metal structural component and the second metal structural component.

15. A metal to composite joint for a platform comprising:
a first metal structural component comprising a stepped face and a planar face;
a first set of composite plies comprising faying surfaces complementary to the stepped face of the first metal structural component;
a second metal structural component comprising a stepped face and a planar face;
a second set of composite plies comprising faying surfaces complementary to the stepped face of the second metal structural component; and
a dividing set of composite plies between the first metal structural component and the second metal structural component providing an escape path for volatiles between the first metal structural component and the second metal structural component.

16. The metal to composite joint of claim 15, wherein the dividing set of composite plies extends between and is adhered to the planar faces of the first metal structural component and the second metal structural component.

17. The metal to composite joint of claim 15, wherein the dividing set of composite plies extends between and is adhered to the stepped faces of the first metal structural component and the second metal structural component.

18. The metal to composite joint of claim 15, wherein the first metal structural component and the second metal structural component comprise titanium.

19. The metal to composite joint of claim 15, wherein the platform is a wing of an aircraft.

20. A method of forming a metal to composite joint of a structure comprising:
placing a dividing set of composite plies atop a first metal structural component;
placing a second metal structural component onto the dividing set of composite plies; and
bonding the first metal structural component and the second metal structural component to the dividing set of composite plies.

21-25. (canceled)

26. (canceled)

27-30. (canceled)
